(19) United States
(12) Patent Application Publication
(10) Pub. No.: US 2010/0261133 A1
(43) Pub. Date: Oct. 14, 2010

(54) Devices, systems, and methods for repositioning the mandible

(76) Inventor: Ronald G. Lax, Port Orange, FL (US)

Correspondence Address: RYAN KROMHOLZ & MANION, S.C., POST OFFICE BOX 26618, MILWAUKEE, WI, 53226, US

(21) Appl. No.: 12/384,693

(22) Filed: Apr. 8, 2009

(51) Int. Cl. A61C 9/00

(52) U.S. Cl. 433/71; 433/215

(57) ABSTRACT

A system and method for making an improved mandibular repositioning device includes a pair of tooth fixation element premolds, a pressure molding cap and at least one adjustment mechanism. The premolds include resin and reinforcing material within a flexible envelope. The pressure molding cap includes a rigid shell and an inflatable bladder. The tooth fixation element premold is placed on the patient's teeth. The pressure molding cap is placed over the premold and the bladder is filled. The pressure of the bladder forms the premold to the patient's teeth. The pressure is released once the resin is set and the formed tooth fixation element may be removed from the patient's teeth. After a tooth fixation element is created for both the top and bottom sets of teeth an attachment mechanism is coupled to both tooth fixation elements to adjustably coupled the tooth fixation elements to each other.

### BACKGROUND OF THE INVENTION

The National Sleep Foundation reports that at least 40 million Americans suffer from sleep disorders, and fatigue contributes to more than 100,000 police-reported highway crashes, causing 71,000 injuries and 1,500 deaths each year in the United States.

Lack of sleep affects cognitive functioning, emotional and physical health. The immune system requires sleep to fight off disease and endure illness. Sleep disorders such as snoring, sleep apnea and upper airway resistance syndrome may lead to fatigue, irritability, depression forgetfulness, stress, obesity and high blood pressure. Many accidents in addition to vehicular ones can be traced to lack of quality sleep.

Sleep Disordered Breathing (SDB) has been recognized since the 1980's as a world wide health problem. There are several different conditions that fall under SDB, the major ones being Snoring, Obstructive Sleep Apnea (OSA) and Upper Airway Resistance Syndrome (UARS)

Obstructive Sleep Apnea (OSA) is the most commonly recognized form of sleep disordered breathing. OSA occurs when issues in the upper airway collapse at intervals during sleep, blocking the passage of air. Hyponea is a partial blockage that causes shallow breathing and falls under the classification of UARS. Snoring is a very common sleep breathing disorder that also has been shown to affect the quality of sleep and adversely affect mental and physical alertness.

Breathing obstructions can occur many times during the sleeping period, often hundreds of times a night. The medical description of an apneic event is cessation of breathing for 10 seconds or more. However, many patients experience events lasting 60 seconds or longer. During a partial or complete obstruction of the airway, blood saturation drops from the desirable high 90 percent range, and several events ensue. Lowered blood oxygen levels trigger a response of the brain to prevent asphyxia. A “sympathetic discharge” of adrenaline, corticosteroids and other agents raise blood pressure, pulse rate, muscle and brain activity to protect the unconscious sleeper from death. These events, when repeated night after night result in damage to the heart and circulatory system, substantially increasing the likelihood of heart failure or stroke. Untreated, OSA patients may lose many years from their expected lifespan.

Sleep apnea has been shown to be associated with a higher incidence of many medical conditions other than problems of the heart and circulation. These conditions include pulmonary hypertension, diabetes, kidney failure, peripheral nerve damage, liver damage, seizures, epilepsy and other nerve disorders, headaches, irregular menstrual periods, high-risk pregnancies, eye disorders including glaucoma, conjunctivitis, dry eye, other infections and irritations, and possibly, Alzheimer's disease.

Patients with sleep apnea are repeatedly aroused from sound sleep by the brain when oxygen saturation falls, gasping for breath, and then resuming sleep. They are typically not aware of the arousal, but sleep studies show that the OSA sufferer enjoys very little level 4 or REM sleep, that sleep that is most restful and leads to next day energy and wakefulness. Consequently, daytime sleepiness is very common for the OSA patient.

Many factors may contribute to sleep disordered breathing. A common cause is relaxation of the muscles of the tongue that allows the tongue to move backward into the oropharynx, contacting the pharyngeal tissue, restricting or occluding the airway. FIG. 1 is a view of a portion of the human head showing the nasal cavity, tongue, oral cavity, oropharynx and soft palate. In this view the mandible is shown in the retrognathic position as occurs during sleep with patients exhibiting Obstructive Sleep Apnea. During such an occurrence, the mandible is moved in a posterior direction. The airway is occluded by the back surface of the tongue. The tongue may further deflect the soft palate into the oropharynx.

One device used to control sleep apnea is the CPAP (continuous positive airway pressure) device which has been shown to be effective in controlling sleep apnea. However, patient compliance is quite low, with a high percentage of users discontinuing use of these expensive devices after a short period. It has been reported that long time compliance (continued nightly usage) varies from 50% in highly motivated patients to less than 25%, according to some anecdotal reports. Discomfort, inconvenience, claustrophobia and social stigma have all been cited as reasons that most patients are unable or unwilling to tolerate these machines on an ongoing basis.

Another device used to control sleep apnea, snoring and upper airway resistance syndrome is a mandibular repositioning device or oral appliance. This is an intra oral device that fits over the upper and lower teeth that, when fitted and adjusted properly by a well-trained dentist, can provide relief of apneic episodes. When fit properly, such devices keep the jaw from dropping open and backward during sleep and also position the jaw slightly forward of the normal relaxed position. This forward displacement of the mandible draws the tongue with it by attachment of the genioglossus muscle of the tongue to the posterior surface of the mandible. Preventing the jaw from falling back (a condition known as retrognathia) is especially helpful in minimizing airway obstruction by the back of the tongue.

The amount of movement is limited, however these devices provide relief for approximately 50% of those who suffer with sleep apnea. In fact, for patients with mild to moderate OSA and those suffering with UARS, mandibular repositioning devices have been found to be almost as effective as CPAP and, according to many reports, better tolerated by patients. Mandibular repositioning devices have grown in popularity with increased public awareness of sleep apnea and related health problems.

However, there are difficulties associated with current mandibular repositioners—while a very small percentage are “boil and bite” devices, the most effective ones are custom made, requiring impressions and models made by a dentist, then fabricated by a dental laboratory that specializes in oral appliances. The process of manufacturing these devices is time consuming and requires a high degree of skill to produce a properly fit appliance. Consequently, they are expensive and are not quickly available, typically taking several weeks after the dental impressions have been made for the patient to obtain the finished device.

The process of producing these devices involves having the dentist take impressions of the upper and lower teeth, make a wax impression of the bite at the incisors for determining the relation of the upper teeth to the lower teeth, casting dental plaster models of the teeth and sending these items to a dental laboratory specializing in fabrication of the MRD. The dental laboratory, working from the models, first adds a sheet wax covering material that will determine the wall thickness of the device and then will hand smooth and shape the exterior of the wax where the final casting will contact the tongue and cheeks.

The lab technician will then cast a silicone rubber mold material over the wax and plaster model. After curing, the mold is cut apart, inspected and prepared for casting of the portions of the device that will affix to the teeth.

These appliances utilizing cast elements for teeth fixation have many protrusions that are created by the undercuts on the side surfaces of the teeth and the interdental spaces between the teeth. Because the cast materials are quite rigid, the depth of the protrusions are critical—they must extend deeply enough into the spaces to provide a grip on the teeth so that the device does not become dislodged during sleep, but shallow enough that the device can be snapped onto the teeth and easily removed when desired. These conditions require that a skilled technician manually remove excess protruding material from the casting, manually grinding the protrusions on the cast component and repeatedly affix and remove the casting from the plaster model of the patient's teeth until a suitable fit has been attained.

In the case of an adult patient with all 32 teeth, there are 60 such protrusions that must be manually trimmed from the casting. This process is time consuming and contributes to a high product cost.

Although some over the counter “heat and fit” or “boil and bite” devices are available, these devices do not grip the teeth as reliably as custom manufactured appliances and therefore may fall out during sleep. Further, these devices are bulky and uncomfortable and have not been shown to be as effective at controlling sleep disorders such as sleep apnea when compared to custom made appliances.

Many current MRDs use a polymer that softens slightly when immersed in hot water, allowing the MRD to flex or spring past any undercut areas so the user can place the device on the teeth. If placement is attempted with a cold MRD, rigid cast MRDs will not flex enough to snap past undercut areas or accommodate slight tooth misalignment (normal movement of the teeth) making it difficult or impossible to fit the cold appliance to the teeth. However, it is not always convenient or possible to obtain hot water for softening the device, for instance when traveling, being in a public place, or being where the tap water is unsafe and bottled water must be heated and used. Further, if the user needs to remove the MRD for any reason during the night, the MRD must be reheated for insertion.

Some MRDs are produced in a single piece with the positioning of the upper teeth to the lower teeth fixed (not adjustable) but most devices are designed so that the amount of forward movement of the mandible is adjustable, requiring the upper and lower elements to be separate components. Various mechanisms are used to control the amount of movement; most are screw adjustable although some utilize elastic bands, shims or slotted hardware and clamping screws to lock the devices in place after adjustment by the dentist. The majority of present appliances are incrementally adjustable, facilitating gradual movement of the mandible allowing the temporo mandibular joint (TMJ) to gradually become accustomed to the change in position.

Virtually all of the laboratory fabricated oral appliances are made of a cast polymer such as methyl methacrylate (acrylic). These materials are not reinforced and are not especially impact resistant. To resist breakage these appliances are manufactured with wall thicknesses varying from 2 to 5 millimeters. These thick walls and the amount of extension into the roof of the oral cavity and inner tooth surfaces cause the device to occupy a substantial volume within the mouth, taking up space that might otherwise provide room for the tongue. Mechanical attachments for adjustment of the upper (maxillary) and lower (mandibular) portions add more bulk to the appliance, making the MRD less comfortable and giving the wearer the appearance of puffy cheeks and swollen lips. FIG. 2 illustrates the use of a typical mandibular repositioning device.

Obtaining the MRD is inconvenient and most dentists do not offer these to patients, presumably due to the complexity of the process, that several visits are required with the patient and complaints from the patient can be time consuming and may require repeating the entire fitting and ordering process.

The MRDs that are now available have a limited life, often 1 to 1½ years and the expense of custom manufacture with both a dentist and dental laboratory involved is considerable. Most of the presently available appliances must be replaced if any dental work is done that changes the shape of even one tooth.

### SUMMARY OF THE INVENTION

The invention provides devices, systems, and methods for repositioning the mandible including providing an improved mandibular repositioning device and an improved method of making a mandibular repositioning device.

One aspect of the invention provides a method including providing a top premold and a bottom premold, each of the premolds having a flexible outer envelope, the outer envelope defining an interior cavity and reinforcing material, the reinforcing material being located within the interior cavity. The method further including providing a cap, the cap being sized and top teeth, forming the bottom premold to the bottom teeth, and installing adjustment hardware connecting the top premold to the bottom premold.

The forming of the top premold step may include placing the top premold over the top teeth, placing the cap over the top premold, inflating the cap bladder, and applying curing energy to the top premold.

The forming the bottom premold step may include placing the bottom premold over the bottom teeth, placing the cap over the bottom premold, inflating the cap bladder, and applying curing energy to the bottom premold.

The method may include a premold with resin located within the interior cavity.

The applying steps may include applying heat to the premold.

The applying steps may include applying indirect heat to the premold.

The applying steps may include providing infrared heat means in the cap bladder.

The applying steps may include inserting heated liquid into the cap bladder.

The applying steps may include providing surface heating means on the bladder.

The applying steps may include applying direct heat to the premold.

The applying steps may include providing resistance heating wire within the premold.

The applying steps may include providing printed resistance heating circuits within the premold.

13. The method of claim 10 wherein the applying steps further comprise providing carbon fiber fabric within the premold.

The applying steps may include providing metallic fabric within the premold.

The curing energy may take the form of light.

The premold may include at least one entrance port formed in the outer envelope, the entrance port extending to the interior cavity.

The premold may include at least one distribution channel, the at least one distribution channel located within the interior cavity and being in fluid communication with the entrance port and at least one evacuation hole formed in the outer envelope, the at least one evacuation hole being in fluid communication with the at least one of the at least one distribution channels.

The forming steps may include filling the premold with a mixture of resin and catalyst.

The forming steps may include filling the premold prior to insertion into the patient's mouth.

The forming steps may include providing a support tray, the support tray having a base and a raised portion extending from the base, the raised portion being sized and configured to matingly engage the premold.

The forming steps may include placing the premold on the support tray, attaching a filling tube to the entry port, attaching a suction tube to the evacuation port, and filling the premold with a mixture of resin and catalyst through the filling tube.

Another aspect of the invention provides a system including at least one premold, the premold having a flexible outer envelope, the outer envelope defining an interior cavity and reinforcing material, the reinforcing material located within the interior cavity. The system further includes at least one cap, the cap being sized and configured to removably engage the top and bottom premold, the cap including an inflatable bladder. The system further includes adjustment means.

The system may includes at least one premold includes a mixture of resin and catalyst in the interior cavity.

The premold may include resistance heating wire within the interior cavity.

The premold may include resistance heating circuit within the interior cavity.

The premold may include carbon fiber fabric within the interior cavity.

The premold may include metallic fabric with low impedence conductor edges within the interior cavity.

The premold may include photoinitiated resin within the interior cavity.

The premold may include at least one entrance port, the entrance port extending through the outer envelope to the interior cavity.

The premold may include at least one distribution channel within the interior cavity, the distribution channel being in fluid communication with the entrance port.

The premold may include at least one evacuation port, the evacuation port extending through the outer envelope to the interior cavity

The cap bladder may include at least one heating element.

The cap bladder may include at least one infrared heating element.

The system may include a filling tray, the filling tray including a base and a raised portion, the raised portion being sized and configured to engage the at least one premold.

The system may include a filling syringe, the filling syringe being sized and configured to provide resin to the entrance port.

### BRIEF DESCRIPTION OF THE DRAWINGS

FIG. 1 is a lateral view of a portion of the human head showing the tongue, oral cavity, oropharynx and soft palate wherein the mandible is in retrognathic position.

FIG. 2 is the lateral view of a portion of the human head of FIG. 1 utilizing a prior art mandibular repositioning device.

FIG. 3 is a partially cut-out perspective view of an embodiment of a tooth fixation element premold according to the present invention.

FIG. 4 is a partially cut-out perspective view of an embodiment of a pressure molding cap according to the present invention with the pressure molding cap engaging a tooth fixation element premold.

FIG. 5A is a perspective view of an upper and a lower tooth fixation element placed on a set of teeth.

FIG. 5B is a cross section view of a tooth fixation element.

FIG. 5C is a detail of the cross section of FIG. 5B showing the layers of reinforcing materials and bonding materials.

FIG. 6 is a cross sectional view of a tooth fixation element premold and pressure molding cap placed on a set of teeth.

FIG. 7 is a cross sectional view of a tooth fixation element premold and pressure molding cap placed on a set of teeth with the pressure molding cap bladder pressurized, causing the premold to conform to the teeth.

FIG. 8 is a cross sectional view of a tooth fixation element having been molded to the teeth.

FIG. 9 is a perspective view of the tooth fixation element of FIG. 8.

FIG. 10A is a perspective view of an embodiment of a mandibular repositioning device according to the present invention.

FIG. 10B is a close-up perspective view of a portion of an embodiment of an adjustment mechanism for the mandibular repositioning device of FIG. 10A.

FIG. 10C is a sectional view taken along line 10C-10C of FIG. 10B.

FIG. 11 is the lateral view of a portion of the human head of FIG. 1 utilizing the mandibular repositioning device of FIG. 10.

FIG. 12 is a perspective view of an alternative embodiment of a tooth fixation element premold layered reinforcing material according to the present invention.

FIG. 13 is a perspective view of an alternative embodiment of a premold according to the present invention.

FIG. 14 is a perspective view of a premold filling tray according to the present invention with a premold being placed on the premold filling tray.

FIG. 15A is a perspective view of the premold filling tray of FIG. 14 with a premold in place and vacuum distribution media placed over the base surface of the filling tray.

FIG. 15B is a cross section of the premold filling tray with a premold in place and vacuum distribution media placed over the base surface of the filling tray of FIG. 15A.

FIG. 16 is an embodiment of a resin dispensing device according to the present invention.

FIG. 17 is the lateral view of a portion of the human head of FIG. 1 with the tooth fixation elements of the present invention on the teeth and a locator block inserted to affix the-adjustment mechanisms to the tooth fixation elements.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

A mandibular repositioning system 10 according to the present invention preferably includes a pair of tooth fixation element premolds 12, a pressure molding cap 14 and adjustment mechanism 16.

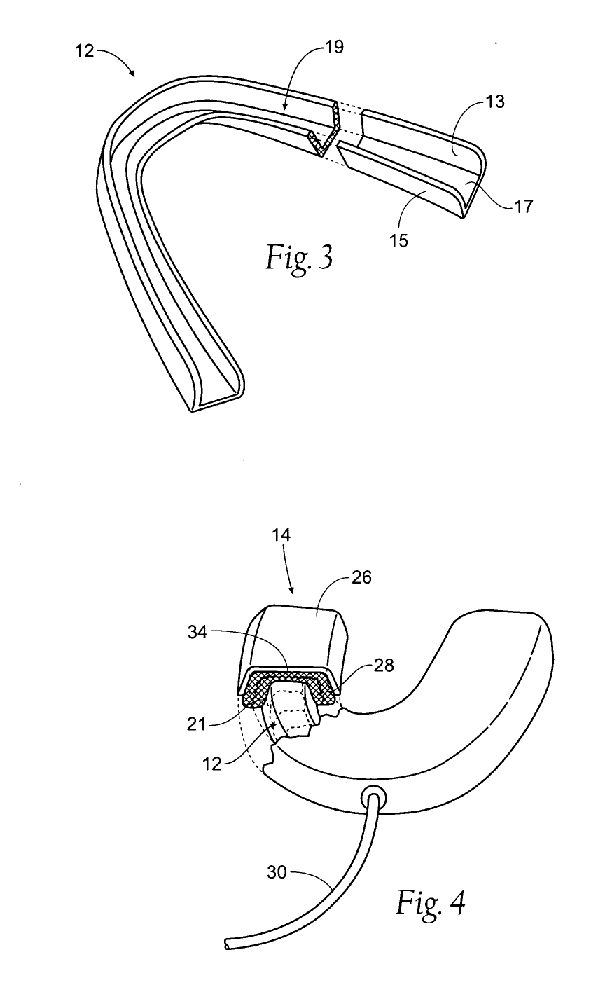

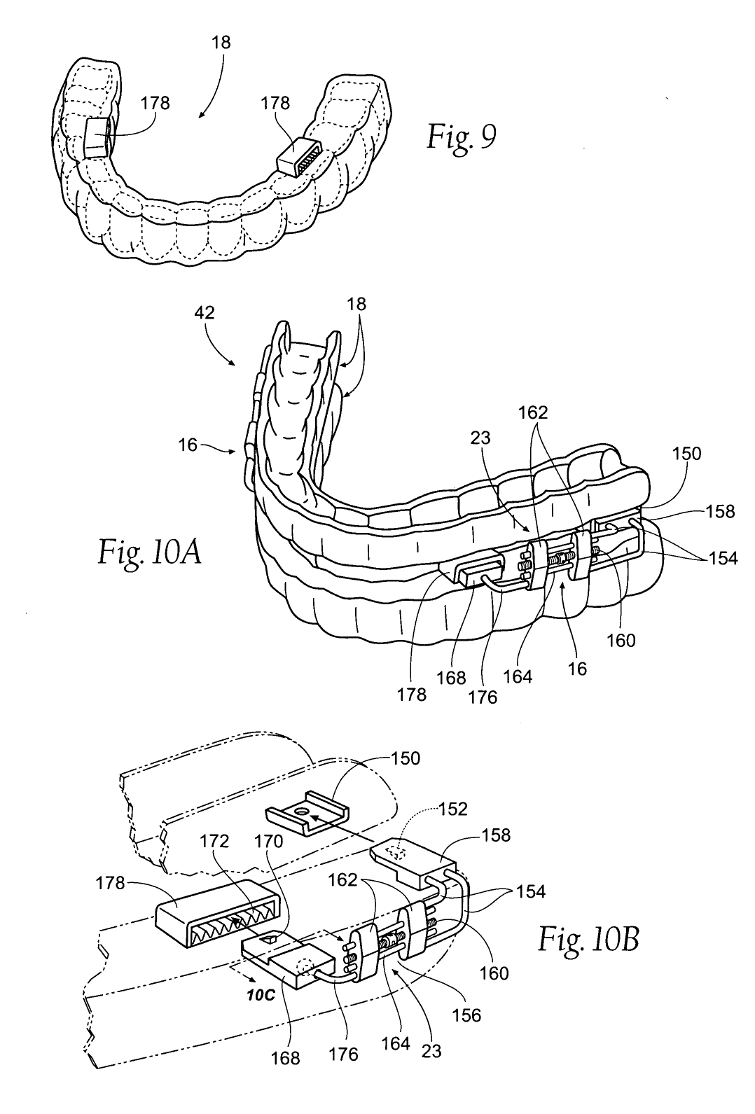

FIG. 3 shows a tooth fixation premold 12 (also referred to simply as a premold) viewed looking into the tooth channel according to the present invention. The mandibular repositioning system 10 preferably includes two premolds 12. The premold 12 will be formed, as described below, to create a tooth fixation element 18 (see FIG. 9).

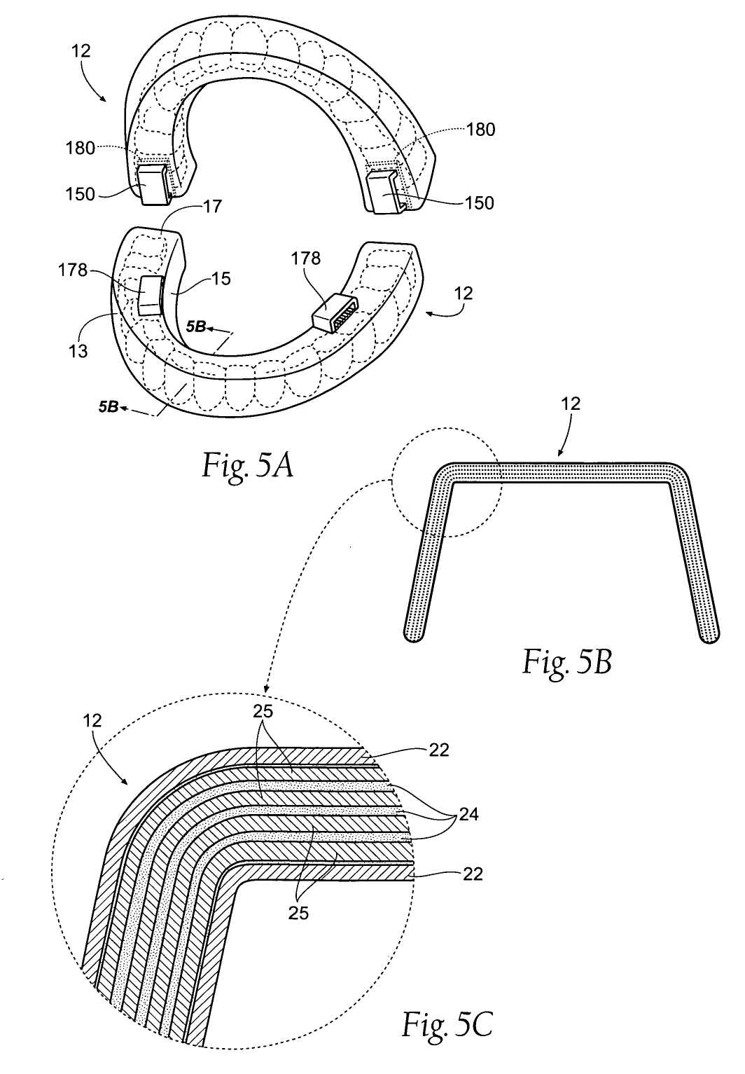

The premold 12 is preferably generally u-shaped. The premold 12 preferably includes a facial portion 13, a lingual portion 15, and an occusal portion 17. The facial portion 13 and the lingual portion 15 are generally parallel with the occusal portion 17 extending there between forming a channel 9. The premold 12 preferably includes reinforcing material 20 within a premold envelope 22 as shown in FIGS. 3 and 5C

The premold envelope 22 is preferably made of a flexible elastomeric material such as silicone rubber, polyurethane or other thermoplastic elastomer to allow the premold 12 to be formed to a patient's teeth.

The reinforcing material 20 may be provided using any means known in the art. For example, it is contemplated that the reinforcing material 20 may be formed as layers of reinforcing materials 24 that have generally the same unshaped channel configuration as the premold 12 itself. The reinforcing layers 24 may be constructed of fabric such as fiberglass cloth, mat, aramid fiber or carbon fiber. The layers 24 may be formed over or into a mold. If fabric is utilized, the fabric may be slit or notched to allow the portions that extend into the lingual and occlusal areas to fold downward without wrinkling or failing to lie against the mold sides. Further, the different layers of fabric may preferably be slit or notched at different locations so that any such slits or notches will be covered by unnotched fabric in the layer above or below. Although any number of layers 24 of fabric may be utilized it is contemplated that preferably between 2 to 4 layers will provide the spring action, strength and resistance to breakage necessary for this application. The layers 24 are preferably stitched, tacked, or bonded to hold their shape. It is further contemplated that resin or polymer bonding material 25 may be layered between the reinforcing layers 24 as shown in FIG. 5C.

The reinforcing layers 24 may be made larger than the final size and then trimmed so that it will fill out the interior of the premold envelope 22 leaving no areas that are not filled with the reinforcing material 20. This would provide consistency in the make up of the finished tooth fixation element 18 and avoid embrittled “resin rich” or “resin only” areas in the finished tooth fixation element 18.

It is further contemplated that the reinforcing material 20 may be a custom made shape that would conform to the preform envelope 20 with no notching needed to lay flat. For example, and not by way of limitation, a tubular knit similar to a hollow shoe string may be utilized to conform to the U-shaped configuration of the premold envelope 22.

As will be described in more detail below, it is contemplated that the premold 12 could be manufactured with resin and catalyst inside the premold envelope 22. In this manner a “ready to use” premold 12 is provided. Alternatively it is contemplated that the resin may be injected into the premold envelope 12 along with a catalyst at the time the premold 12 is ready to be formed to the patient's teeth as will be described in more detail below.

The mandibular repositioning system 10 preferably further includes a pressure molding cap 14, as shown in FIG. 4. The pressure molding cap 14 is preferably generally u-shaped. The pressure molding cap 14 preferably includes a channel 21 sized and configured to received a premold 12. As shown in FIG. 4, the pressure molding cap 14 is preferably sized and configured to fit over the premold 12.

The pressure molding cap 14 preferably includes a rigid outer shell 26 and an interior bladder 28. The pressure molding cap 14 further includes a fluid port 30. The bladder 28 is preferably made of a flexible material to allow the bladder 28 to expand when fluid is introduced to the fluid port 30. If desired, the pressure molding cap 14 may include heating means 34 to provide curing energy to cure the resin within a premold 12, as will be described in more detail below.

The adjustment mechanism 16 may take any form known in the art. Preferably, at least one adjustment mechanism 16 is utilized. In the illustrated embodiment of FIG. 10A a pair of adjustment mechanisms 16 are utilized. An illustrated embodiment of adjustment mechanism 16 is shown in FIG. 10B. The adjusting mechanism 16 preferably consists of a standard orthodontic expander 156 that is modified for attachment to the tooth fixation elements 18. Each orthodontic expander 156 consists of two slidable blocks 162 that are moved inward or outward by a threaded screw 160 and move along guide pins 164, and have up to four attachment arms 154, 176, two from each slidable blocks. One or more of the attachment arms 154 are affixed to an anchoring tab 158 that is sized to engage with a receiver boss 150 that may be molded into or coupled to the upper tooth fixation element 18. On the opposite end of the orthodontic expander 156, one or more of the attachment arms 176 are affixed to a second anchoring tab 168 that is configured to engage with receiver boss 178. The anchoring tab 168 may have locators as shown in FIG. 10C, configured to engage with matching locators 172 within the receiver boss 178. The means of affixing the at least one adjustment mechanism 16 will be described in detail below.

It is contemplated that the receiver bosses 150, 178 of the adjustment mechanism may be affixed to the tooth fixation element 18 in any manner known in the art. The illustrated embodiment of FIG. 5A, shows one manner of coupling a receiver boss 150 to the top tooth fixation element 18. In the illustrated embodiment the receiver boss 150 includes a plate 180. The plate 180 is embedded within the reinforcing layers 24 of the tooth fixation element 18. It should be understood that any alternative means of affixing any portion of the adjustment mechanism 16 to a tooth fixation element 18, including, but not limited to the use of machine screws, nuts, self tapping screws, bonding with adhesives, sonic welding or other melt attachment means may be utilized.

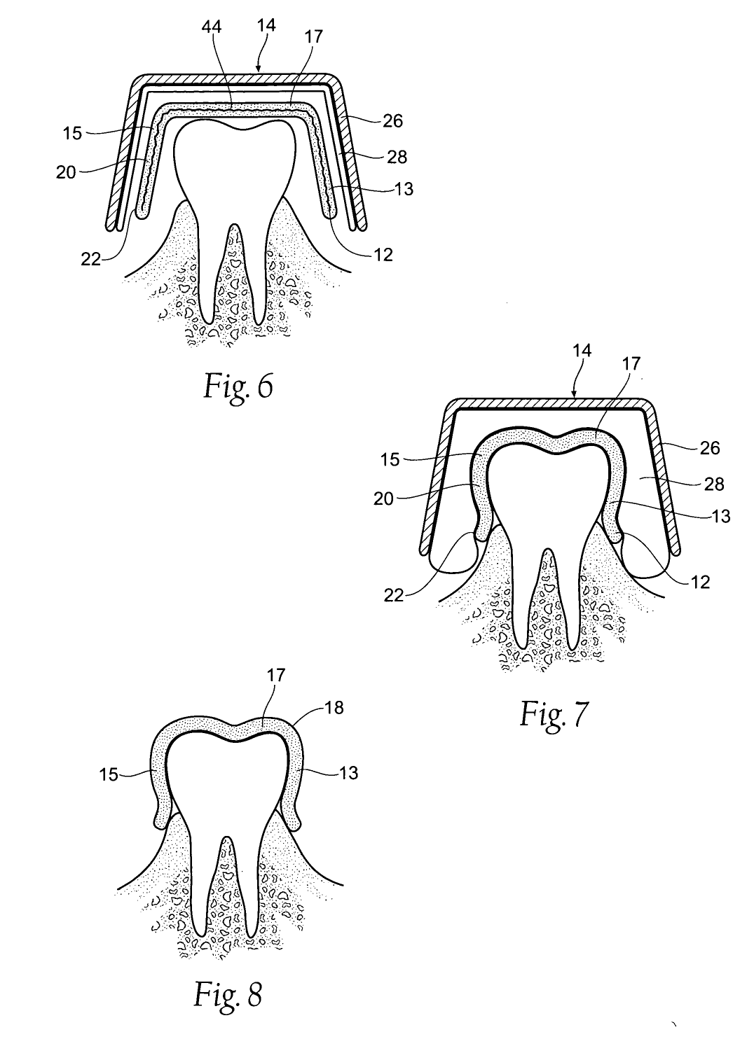

In use, the premold 12 is placed onto a patient's teeth 36 and pressed into firm contact as shown in FIG. 5A. The pressure molding cap 14 is then placed over the premold 12 as shown in FIGS. 4 and 6. The patient is instructed to bite down on the pressure molding cap 14. The bladder 28 of the pressure molding cap 14 is internally pressurized, as shown in FIG. 7, by introducing a fluid to the fluid inlet. The fluid may be of any type including liquid or gas. The fluid may be of any type known in the art including, but not limited to, air. It is contemplated that the pressure applied to the bladder 28 of the pressure molding cap should be no more than 300 mg hg. The premold 12 is held tightly until the polymer within the premold 12 has cured or set.

The pressurization of the bladder 28 presses the premold 12 against the teeth's surfaces and into the spaces between the teeth at the gum line. The resin with the envelope 22 flows and exerts even pressure within the envelope 22 causing the envelope 22 to conform to the shape of the teeth and the spaces between the teeth.

The amount of protrusion into these spaces is controlled by the thickness and degree of elasticity of the film envelope 22 of the premold 12. If a thinner skin is utilized, a higher Shore A harness will be suitable. If a thicker skin is utilized, a lower Shore A hardness will be suitable. The Shore A hardness is preferably not less than 20 and not greater than 60. The skin thickness is preferably from 0.04 mm to 0.50 mm. It is contemplated that the elongation at break for the envelope 22 material is preferably not less than 400% and not greater than 7200%. Use of a material falling within these ranges will provide smooth, rounded protrusions requiring no finishing.

In use, the protrusions act as locking elements which help retain the tooth fixation element on the patient's teeth. It is contemplated that the amount of engagement of the protrusions, or detents, into the interdental spaced is preferably from 0.3 mm to 1.5 mm. It should be understood that the interdental spaces between all teeth are used for gripping.

It should be understood that because no hand finishing is required variation is eliminated and the tooth fixation element 18 will have a more reliable and consistent fit on the patient's teeth. Further, removal of the tooth fixation element 18 from the teeth is aided as there are no sharp or abrupt corners on the tooth fixation element 18.

The pressure on the bladder 28 is maintained until the polymer has cured or set. The polymer may be cured or set using any means known in the art. Preferably, if the polymer is a thermosetting resin, it may be “set” by applying curing energy to the premold 12. For example, and not by way of limitation, the resin may be cured using heat such as that supplied by a heated fluid or radiant heating means positioned within either the premold 12 or the pressure molding cap 14 or by light, such as that supplied by a light emitting source positioned within either the premold 12 or the pressure molding cap 14. It is contemplated that the bladder 28 and/or envelope 22 may be transparent to infrared for radiant heating or to U.V. or visible light in the case of systems using a photoinitiated curing system.

After the resin has cured, the bladder 28 pressure is released. The pressure molding cap 14 may then be removed, leaving a tooth fixation element 18 in place. The tooth fixation element 18 conforms to the shape of the teeth 36 as shown in FIGS. 8 and 9. Preferably, the facial and lingual portions 15, 13 of the of the tooth fixation element 18 curve under the widest part of the patient's tooth, providing an “undercut” grip on the tooth. The tooth fixation element 18 may then be removed to attach the adjustment mechanism 16. It should be understood that the pressure molding cap 14 serves only the purpose of causing the premold to conform to the teeth and is not needed after curing or setting of the tooth fixation elements to the shape of the teeth.

It is contemplated that the pressure molding cap 14 may be a single use item used only to mold a pair of tooth fixation elements 18 which make up a single mandibular repositioning device 42, or it may be reused to mold pairs of tooth fixation elements for multiple devices 42. If the pressure molding cap 14 is to be reused, it is contemplated that it may be manufactured using medically approved sterilizable materials or placed in a thin wall disposable plastic bag that isolates the pressure molding cap 14 from the mouth of the patient and which bag will be discarded after use in the manner that is well proven and accepted for providing sterility for dental and medical equipment.

It should be understood that the mandibular repositioning device 42 preferably includes a pair of tooth fixation elements 18. A bottom tooth fixation element 18 is fitted to the patient's bottom teeth. A top tooth fixation element 18 is fitted to the patient's top teeth.

After both the bottom and top tooth fixation elements 18 are formed, each at least one adjustment mechanism 16 is attached to both of the tooth fixation elements 18 as shown in FIGS. 10A though 10C. The illustrated embodiment of FIG. 10A includes two adjustment mechanisms 16. Preferably, the bottom and top tooth fixation elements 18 are adjustably coupled to each other.

In the illustrated embodiment an adjustment mechanism 16 is coupled at a first end to the attachment boss 150 located near the rear end of the top tooth fixation element 18. The bottom or lower tooth fixation element 18 will have an attachment boss 178 located roughly halfway between the rear end of the tooth fixation element 18 and the front portion that covers the incisors as shown in FIG. 10A Each attachment boss 150, 178 is preferably coupled to an adjustment mechanism 16 using a locking tab 158, 168 having a locking hook 152 which will engage dentent means within the mounting boss as shown in FIG. 10B. The mating recess is preferably sized and configured to engage the locking hook 152 and may take any form known in the art including, but not limited to a hole or notch. It is alternatively contemplated that the adjustment mechanism may be coupled to the tooth fixation element 18 using any mechanical, welding or bonding means known in the art.

It is contemplated that for example, and not by way of limitation, each attachment boss 150, 178 may be coupled to the fixation element 18 using any means known in the art including, but not limited to, at least one machine screw (not shown). It should be understood that as the central adjusting screw 160 in FIG. 10B of the expander 23 when turned the opposed attachment bosses 150, 178 will move either outward or inward causing the top tooth fixation element 18 and the bottom tooth fixation element 18 to move relative to one another.

In a preferred means of assembling the mandibular repositioning device 42, after the upper and lower tooth fixation elements 18 have been molded to the teeth shape, the dentist or technician will follow these steps in attaching the at least one adjustment mechanism 16 and making the first setting to the device 42:

(1) The patient will be instructed to close his mouth in a comfortable position and the dentist will note and measure the position of the lower jaw relative to the upper, taking a wax impression or other measuring means.

(2) The dentist will instruct the patient to protrude the lower jaw as much as possible and the dentist will determine the maximum protrusion that the patient can comfortably attain, measuring the protrusion using a wax bite block or other means well known to the dental profession.

(3) The dentist will use a notched rubber block 220 that fits between the upper and lower front surfaces of the tooth fixation elements 18 to stabilize and hold the amount to lower jaw protrusion to approximately 25% of the amount the patient can attain under maximum effort. This will be the starting point for initial mandibular advancement.

(4) The dentist will then insert the rearmost anchoring tab 158 into the mounting boss 150 and the locking hook 152 will engage the detent means within the mounting boss, locking the tab 158 in place.

(5) The dentist will then insert the front anchoring tab 168 into the mounting boss, engaging the set of registering teeth 172 that are nearest to the setting that has been determined to be about 25% protrusion.

(6) The dentist will then repeat the above for the opposite side of the mouth.

(7) Final small adjustments can be made by turning the adjusting screw 160 using an adjusting pin that may be supplied with the device 42.

It should be understood that this means of assembly will be quite fast, require no special tools and by being done while the mandibular repositioning device 42 is in the patients' mouth, errors in the beginning setting can be prevented.

The patient will then be instructed as to how to wear the device 42 and is preferably instructed wear the device 42 at this setting for at least one night to become accustomed to the device 42. Preferably, the patient will wear the device 42 at the first setting for several nights. The patient may then begin making small adjustments to the device 42 until the desired amount of mandibular advancement is achieved. Preferably the patient will wear the device 42 for at least one night at each adjustment level. It is contemplated that the patient may wear the device 42 for several nights at each adjustment level.

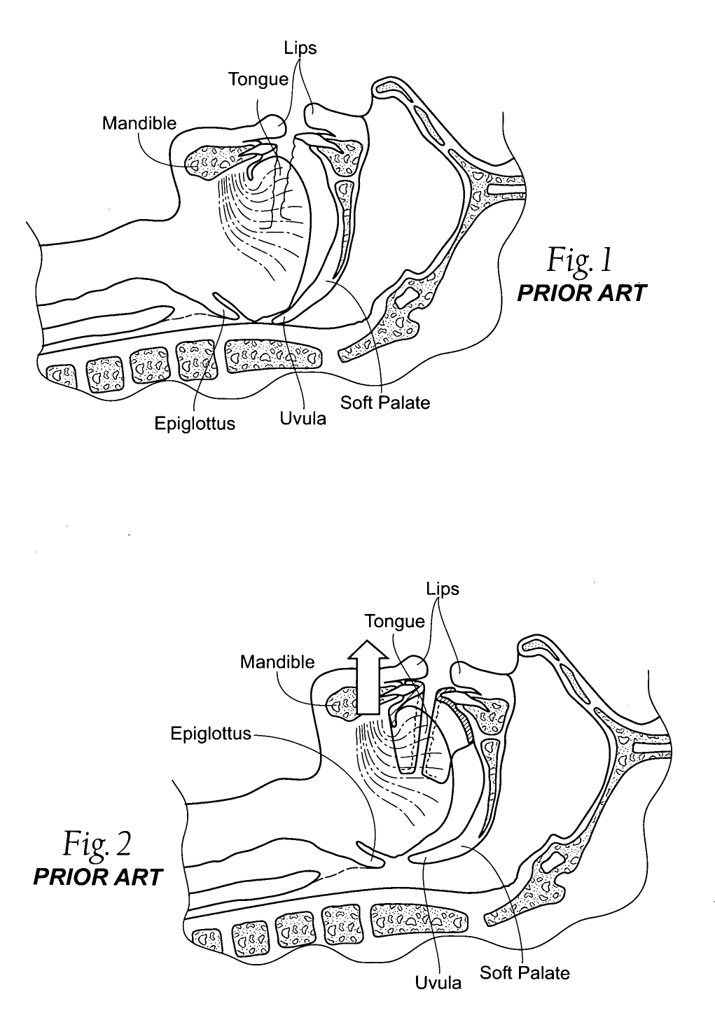

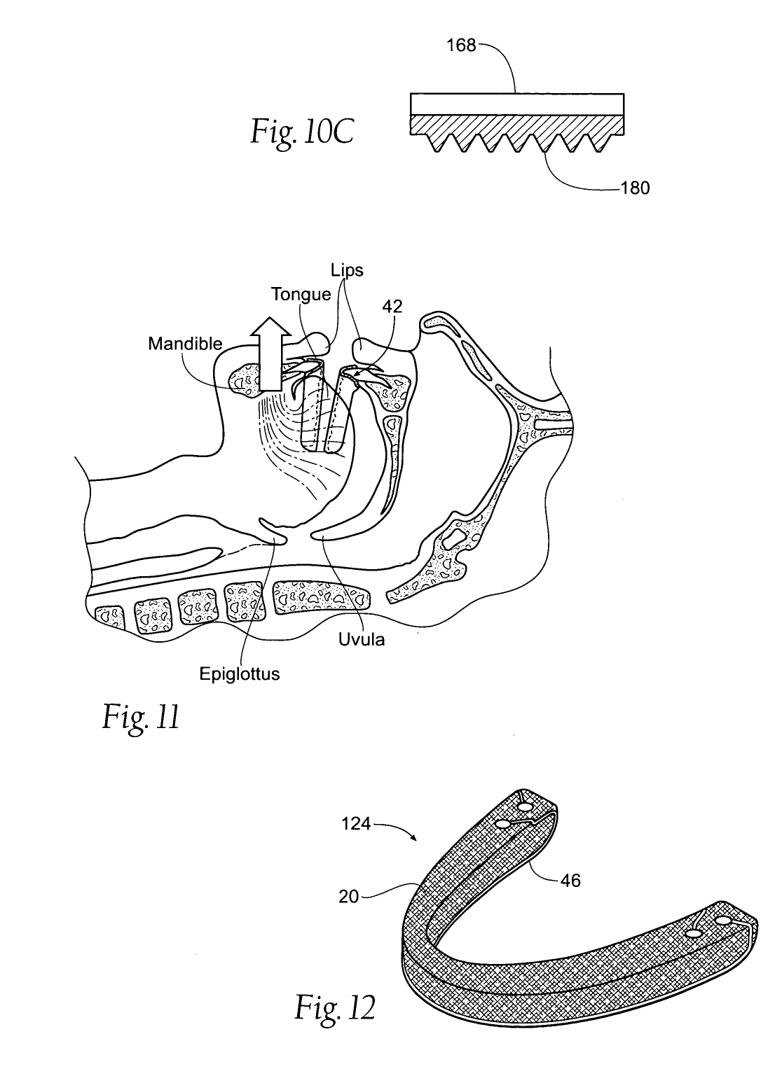

FIG. 11 shows a mandibular repositioning device 42 in use in a human mouth. The mandibular repositioning device 42 urges the mandible forward, drawing the tongue forward and leaving the airway unobstructed. The mandibular repositioning device 42 of FIG. 11 provides increased space in the oral cavity as compared to the prior art shown in FIG. 2. The mandibular repositioning device 42 of FIG. 11 also provides increased space within the oral cavity as compared to present mandibular advancement devices and allows the tongue to repose further forward as compared to the prior art shown in FIG. 2. Furthermore, the mandibular repositioning device 42 of FIG. 11 does not deflect the lips outwardly as much as the prior art device shown in FIG. 2, which makes the mandibular repositioning device 42 more comfortable to the user and less obvious to observers.

It is well known to the dental profession that if jaw displacement forces are concentrated on just a few teeth, individual teeth may be moved. FIG. 11 shows the minimum amount of tooth coverage of each tooth fixation element 18 to distribute forces evenly over the teeth and prevent movement of any individual teeth. The tooth fixation elements 18 preferably reach at least a point just inferior to the upper gum line. Preferably, the tooth fixation elements 18 will extend rearward as far as the last molars and cover the last molars. However, it is also contemplated that, especially with patients with missing teeth, the tooth fixation elements 18 may stop slightly short of the position of the last molar.

For example, it is contemplated that the tooth fixation elements 18 may rely on the first and second premolars, the canines and the incisors for fixation. It is further contemplated in such a situation, the tooth fixation elements 18 may include a portion sized and configured to engage the patient's gums (not shown). For example, the lingual portion of the premold may extend further beyond the gum line to engage both the teeth and the gums, hard palate or lingual mandibular surfaces of the patient. In this manner the forces associated with repositioning the mandible are borne by the gums, surrounding tissue and bony structure plus the teeth.

It should be understood that various sizes of premolds 12 may be made available to practitioners providing the mandibular repositioning device 42. The practitioner will then choose the appropriately sized premold 12 and create a mandibular repositioning device 42 for the patient on-site. Because the method does not involve the very arduous fitting and manufacturing steps of the typical mandibular repositioning device, mandibular repositioning devices 42 according to the method described herein are much less expensive than a typical mandibular repositioning device. Because the mandibular repositioning device 42 is created on site, rather than in a laboratory, the mandibular repositioning device 42 is immediately available to the patient. If changes are made to the patient's teeth, or if the device is lost or damaged, a replacement mandibular repositioning device 42 may be made quickly and at a relatively low cost.

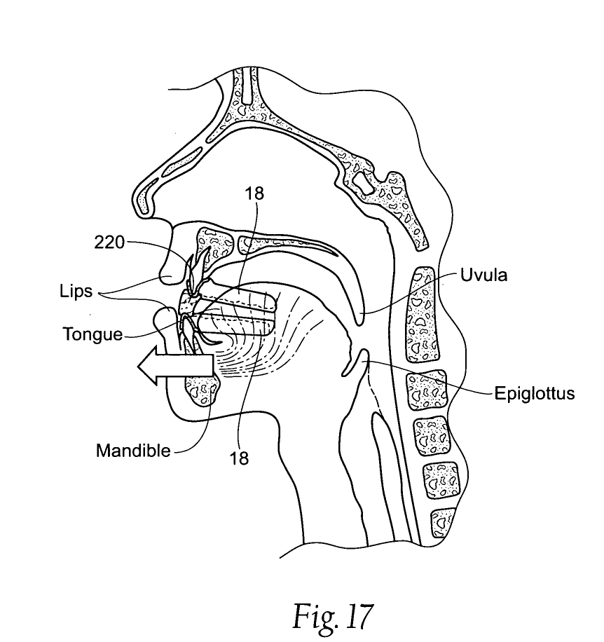

It should further be understood that the configuration of the mandibular repositioning device 42 shown in FIGS. 3 through 17 and described above is more comfortable to the patient than the previously known mandibular repositioning device because the lingual and facial walls 38 of the present device are thinner and flexible and there is more room to accommodate the patient's tongue. The walls 38 are able to be thinner because the reinforced composite polymeric materials used in manufacture of device 42 itself are significantly stronger than cast unreinforced materials. Further, the present mandibular repositioning device 42 is flexible and requires less force to affix and remove the device 42 than previously known mandibular repositioning devices. Further, because of the flexible nature of the reinforced materials at room temperature, the present mandibular repositioning device 42 does not require heating each time it is affixed to the teeth.

It is contemplated that in one embodiment the premold 12 is delivered to the practitioner in a “ready to use” state. In such an embodiment, it is contemplated that the premold 12 will include resin and catalyst sealed within the premold envelope 22 along with the reinforcing material 20. It is contemplated that the premold 12 has multiple layers of reinforcing material 20 which are impregnated or coated with a mixture of bonding resin and a catalyst. The bonding resin is preferably uncured or only partially cured, a material form that is well known in the composites industry as a “B—Staged Prepreg”. “B—Staging” involves a method in which the catalyzing system and resins are formulated to allow a partially cured condition and having the ability to arrest the progress of curing by removing exposure to curing energy. If heat is the curing means, the prepreg is refrigerated for storage and shipment. If the system is light curing (photo initiated), the prepreg will be sealed in a light tight package and may also be refrigerated. The reinforcing material 20 may take any form known in the art including, but not limited to fabric, mat, or unwoven fibers. It is contemplated that a standard prepreg material, as is known in the art, may be utilized. The reinforcement layers 24 may be formed by placing layers of reinforcing material 20 in or on a mold or on a form. Pressure and/or energy (in the form of heat, light, etc.) may then be applied to cause the resin to partially cure or hardened. In this manner the premold 12 will hold it shape, but final curing will take place when the premold 12 is fitted to a patient and delivery of curing energy is resumed.

It should be understood that when utilizing such an embodiment of the premold 12, no mixing or dispensing of resins is required to be performed by the practitioner. This simplifies the fitting process and eliminates equipment and steps that may be required to mix and dispense the resins that are a part of the fitting process for other embodiments of premolds 12.

The premold 12 may be cured using any means known in the art. It is contemplated that the premold 12 may be cured by applying heat to the premold 12 as described above. It is contemplated that the heat may be internal or external to the premold 12.

In an alternate embodiment of the present invention, it is contemplated that in a “ready to use” premold, as described above, the resin bonding system may take the form of a thermoplastic composite. In such an embodiment, the reinforcing material 20 may be impregnated with, or the fibers coated with a thermoplastic resin to form a pre-impregnated reinforcing matrix wherein the bonding resin is present in the reinforcement layers or on the reinforcing material 20. In such an embodiment, the premold 12 will have a virtually unlimited shelf life with no storage temperature limitations such as those that affect, conventional catalyzed resins. The thermoplastic composite may be “set” to the desired shape by raising the temperature of the thermoplastic bonding resin to the heat transition temperature, causing the resin to flow and form a strong cohesive bond between the reinforcing layers. The resin to reinforcement bond is the basis of strength and flexibility in all composite materials, allowing the molded shape to flex predictably without fracture or fatigue when exposed to repeated flexure.

FIG. 12 shows an embodiment of a thermoplastic resin and carbon fiber reinforcement layup 124 including edge conductors 46. The edge conductors 46 deliver electrical current from an external source to the reinforcing material 20. The current flow through the layers of reinforcing material 20 causes resistive heating of the fibers and elevation of the temperature of the thermoplastic resin. The electrical current may be applied until the resin reaches a temperature sufficient to cause the thermoplastic resin to melt and flow through and over the reinforcing media and cause a bond between the reinforcing layers, fibers, etc. The temperature and amount of time the temperature are maintained depends on the particular resin used and are known in the art.

It is further contemplated that, if desired, at least one thermocouple (not shown) may be implanted into the premold 12. Preferably, the thermocouple is imbedded between the layers of reinforcing material 20. The thermocouple preferably transmits information regarding the temperature of the resin to a control device (not shown). It is contemplated that when the desired temperature is reached, the current flow is stopped and the practitioner waits for the premold 12 to set as the temperature falls below the melt or glass transition temperature. The tooth fixation element 18 will then be conformed to the teeth and gums and the adjustment mechanism 16 can be added as described above.

In an alternative means of controlling the temperature of the melting resin within the premold 12, there may be a fusible link (not shown) that is within the layers 24 of reinforcing material 20. The link may be formulated to melt at a predetermined temperature in the manner of an automatic fire extinguishing sprinkler. When the temperature reaches the preset melt point, the fusible link will melt and cause the flow of electrical current to cease. The temperature will then drop and when it is below the glass transition temperature, the shape will be set. An external current flow indicator (light, meter, etc.) may signal to the dental professional that the melt phase is completed and a timer in the control will indicate when the pressure can be released from the pressure cap 14.

In the above described embodiment utilizing a thermoplastic resin as the bonding polymer, it can be recognized that resins with a low melting temperature are desirable for safety and comfort for any device being formed within the mouth. Several materials that can serve this purpose are available including polycaprolactone.

Referring now to the earlier embodiments of the premold 12 described above, the resin within the premold 12 may be cured by applying a curing energy. The curing energy may take any form known in the art. It is contemplated that curing energy to cure the premold 12 may be provided by heat. The heat may be provided using any means known in the art. It is contemplated, as will be described in more detail below, that heat source may be external to the premold 12 or internal to the premold 12. It is further contemplated that the curing energy may take the form of light.

It is contemplated that a method utilizing such a premold 12 may require storing and shipment of the premold 12 in a refrigerated or frozen state. The premold 12 may then be warmed prior to placement on the patient's teeth. Curing energy is then applied to the premold 12. It is contemplated that the curing energy may comprise heat. For example, the temperature of the premold 12 may be elevated to the temperature required to cure the resin. It should be understood that the temperature of the portions of the premold 12 that contact the teeth or soft tissue of the patient will be kept at or below 130° F. (54° C.) to prevent discomfort or injury to the patient. The interior temperature between the layers of reinforcing material 20 within the reinforcing layers 24 may be higher to accelerate the curing process provided the exterior temperature of the premold 12 is kept at or below 130° F. (54° C.).

As discussed above, it is contemplated that the premold 12 may be cured by an external heat source 34 located in the pressure molding cap. It is contemplated that the external heat source 34 may comprise an infrared heating element located within the bladder 28 of the pressure molding cap 14. In such an embodiment the bladder 28 would preferably be transparent to infrared energy.

It is further contemplated that the external heat source 34 may comprise heated fluid in the bladder 28 of the pressure molding cap 14. In such an embodiment the heated fluid would be utilized both to cure the resin in the premold 12 and to pressurize the pressure molding cap 14 and form the premold 12 to the patient's teeth.

It is further contemplated that external heat source 34 may comprise surface heating means printed on the surface of the pressure molding cap 14 bladder 28. The surface heating means utilize direct current flow through resistive conductor pathways to impart heat to the surface of the premold 12. Such surface heating means are well known and are utilized in applications such as automobile window defrosting mechanisms.

It is further contemplated that the curing energy used to cure the resin may be provided by internal heating means 44 inside the premold 12 itself. It is contemplated that these internal heating 44 means may comprise resistive heating means. It is further contemplated that the internal resistive heating means 44 may be contained on or within the layers of reinforcing material.

It is contemplated that the resistive heating means 44 could take the form of resistance heating wire within the premold 12. The resistance heating wire may take any form known in the art including, but not limited to nickel-chromium (Nichrome®) wire.

It is further contemplated that the resistive heating means 44 could take the form of at least one printed resistance heating circuit within the premold 12. The printed resistance heating circuits preferably utilize PTC ceramics on a heat resistant film. Such films are known in the art and may include products such as Kapton® or Mylar®.

It is further contemplated that the resistive heating means 44 may take the form of carbon fiber fabric as one or more of the layers of reinforcing material 20. In such an embodiment direct current electrical energy may be routed through the fabric causing heating due to resistance of the current flow through the electrically conductive material.

It is further contemplated that the resistive heating means 44 may take the form of a specially woven layer of reinforcing material in which at least a portion of the fibers are metallic such as nickel-chromium. In such an embodiment a low impedance conductor may be provided along the edges of the reinforcing fabric to allow the current flow to pass evenly over the reinforcing fabric. In this manner the temperature of the premold 12 will be raised evenly to cure the resin uniformly throughout the premold 12.

As discussed above, it is further contemplated that the curing energy used to cure the resin within the preform 12 may be provided by exposure to light. In such an embodiment, exposure to light will cause the resin and catalyst within the premold 12 to cure rapidly without significantly elevating the resin temperature. In such an embodiment the resin and catalyst may be of any type of “light curing” or “photo initiated” resin and catalyst system known in the art. The chosen resin preferably exhibits strong adhesion to reinforcing material 20 which is necessary to develop the strength and flexibility needed for this application. In particular, “light curing” resins utilized in dental applications including, but not limited to acrylic (methyl methacrylate) may be utilized. It is further contemplated that other polymeric systems, including but not limited to polyurethanes, polyesters, and vinylesters may be utilized. The light may be applied using any means known in the art and commonly found in a dental office. It is contemplated that in such an embodiment the envelope 22 of the premold 12 may be made of a material that is transparent to light. It is further contemplated that at least a portion of the pressure molding cap may be made of a material that is transparent to light. The light source itself may be located within or adjacent to the bladder of the pressure molding cap.

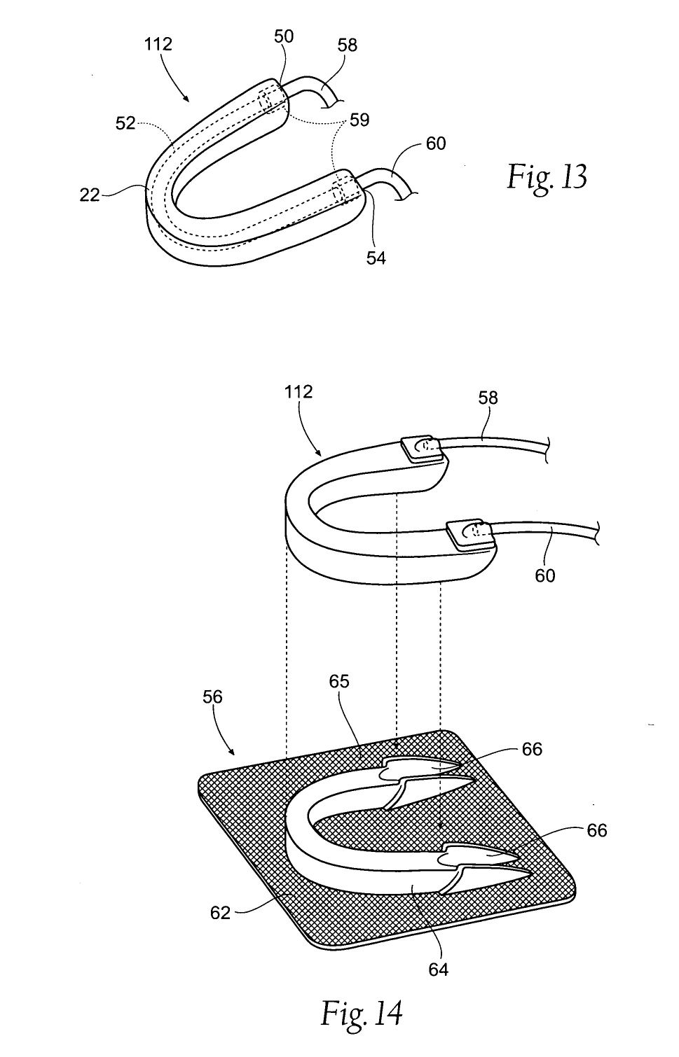

In an alternative embodiment as shown in FIG. 13, the premold 112 may contain only the reinforcing material 20 within the premold envelope 22. The reinforcing material 20 may take any form known in the art including, but not limited to fabric, mat or fibers. The reinforcing material 20 may be anchored in position within the envelope 22 by any means known in the art including, but not limited to adhesive, heat sealing, or mechanical attachment. Preferably, the premold envelope 22 includes at least one port 50 for introducing the bonding resin through resin delivery tube 58 to the premold envelope 22. The premold 112 may further include at least one distribution channel 52 within the premold envelope 22 to distribute resin throughout the premold 112. The premold 112 may further include an evacuation port 54 formed in the premold envelope 22. The evacuation port 54 may be utilized to draw air from the premold envelope 22 to assure complete filling of the premold envelop 22. The evacuation port 54 may further allow some resin to exit the premold envelope 22 through evacuation tube 60, further assuring complete removal of air and filling of the premold envelope 22. The premold 112 may be filled with resin and catalyst using vacuum assisted resin transfer molding, as is known in the art.

It is contemplated that the premold 112 may be filled with resin and catalyst while it is in the patient's mouth or just prior to placing the premold 112 in the patient's mouth.

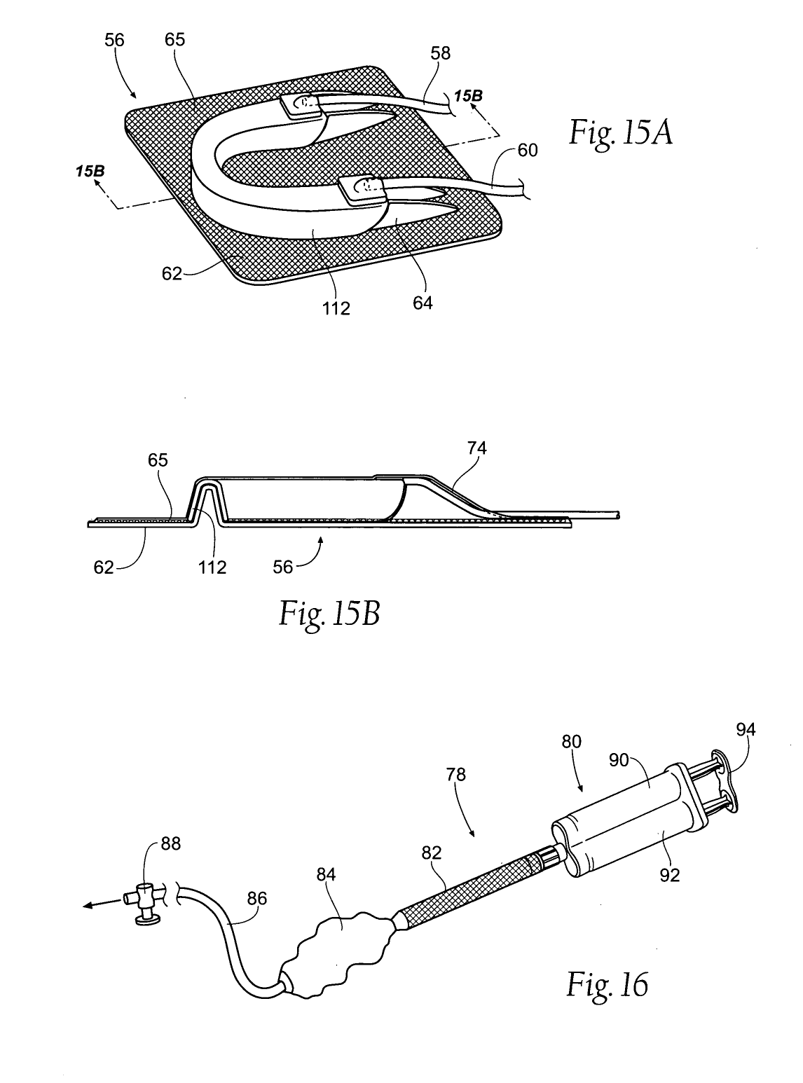

FIGS. 14 through 15B show a supporting tray 56 for supporting a premold 112 while the premold 112 is being filled. In such an embodiment, the premold 112 preferably includes a filling tube 58 coupled to the entry port 50 and a suction tube 60 coupled to the evacuation port 54. The filling tube 58 and the suction tube 60 are preferably removably attached to the premold 12.

The supporting tray 56 preferably includes a base surface 62 and a raised support portion 64 extending from the surface 62. The raised support portion 64 is preferably is sized and configured to fit into the inner cavity of the premold 112. Channels 66 are preferably provided to rout the filling 58 and suction 60 tubes away from the raised support portion 64 A fibrous or porous vacuum distribution pad 65 covers the upper side of base surface 62, and provides a pathway for vacuum evacuation of the air from the space between the support tray 56 and the flexible sealing cover 74.

A thin formed or molded flexible top sealing cover 74 conforms loosely to the supporting tray 56 with the premold 12 in place. The flexible top sealing cover 74 is sealed or bonded to the periphery of the supporting tray 56 and over the filling and suction tubes 58, 60. In use, the air is evacuated by suction from that space between the flexible sealing cover 74 and the upper surface of the supporting tray 56. Atmospheric pressure forces the tray 56 and cover 74 firmly together and the envelope of the preform 12 is collapsed against the reinforcing layers 24. This restricts the space within the envelope 22 to control the amount of resin that can be infused into the envelope 22 so that the resin to reinforcement ratio is in the range of 35% resin to 65% reinforcing material, to attain optimum strength and flexibility in the finished tooth fixation element.

In use, the premold 112 is supplied to the device provider prepackaged and ready for filling. The premold 12 will be in place on the supporting tray 56. The filling 58 and suction 60 tubes are routed through the channels 66 to the exterior of the supporting tray 56 and the flexible top sealing cover 74 is sealed around the periphery of the upper surface of the supporting tray 56. The air is withdrawn through the vacuum port 72. Preferably, atmospheric pressure forces the vacuum formed flexible sealing cover 74 against the premold 112, collapsing the flexible envelope of the premold 112 against the internal reinforcing material 20 and forcing most of the air out of the envelope 22. Resin and catalyst may then be drawn into the premold 112 through the filling tube 58. The resin and catalyst flow through the premold 112 and preferably permeate the reinforcing material 20. Any excess resin may then be evacuated through the suction tube 60.

If desired, it is contemplated that the premold 112 may includes at least one perforated distribution tube 52 positioned within the premold envelope 22. The distribution tube 52 is preferably routed centrally along the occlusal surface of the envelope 22 and is preferably in communication with the evacuation port 54. In this manner air may be evacuated from each location where there is a perforation in the tube 52 and resin may be drawn into the tube 52. Alternatively, one or more distribution tubes or channels with perforations may be positioned within the envelope and one or more separate evacuation tubes or channels may be separated from the distribution tubes to assure even resin coverage through the reinforcement media.

Whether or not the premold 112 is filled on a supporting tray 56 as described above, it is contemplated that resin and catalyst may be provided to the premold 112 entry port by a dispensing apparatus 78. Is it contemplated that the resin and catalyst may be held separately within the dispensing apparatus 78 and mixed just prior to exiting the dispensing apparatus 78. The dispensing apparatus 78 may take any form known in the art. FIG. 16 shows one embodiment of a dispensing apparatus 78. The dispensing apparatus 78 may take the form of a dual plunger syringe 80. The dispensing apparatus 78 preferably includes a static mixer 82 having a first end and a second end, the static mixer 82 being coupled to the syringe 80 at its first end and a reservoir 84 at its second end. The dispensing apparatus 78 preferably further includes a tube 86 having a first end and a second end, the tube being 86 coupled to the reservoir 84 at its first end and a valve 88 at its second end.

The reservoir 84 is preferably made of a flexible plastic film, such as, but not limited to polyethylene or polyvinylchloride to allow the reservoir 84 to expand as the resin mixture is dispensed into the reservoir 84. The reservoir will collapse due to atmospheric pressure as the resin is drawn by suction from the reservoir into the premold 12.

Alternatively, the reservoir 84 may be a molded plastic bellows (instead of a plastic film bag) which may expand as the resin is dispensed from the static mixer 82, then collapse as the resin is withdrawn, as described above.

In use, the syringe 80 is preferably loaded with resin in one cylinder 90 and catalyst in the other cylinder 92. The syringe as described herein may preferably by supplied prefilled with the appropriate resin and catalyst system for use by the dental professional providing the mandibular advancement device. The plunger 94 is pressed causing the resin and catalyst to flow through the static mixer 82 and into the reservoir 84. The plunger 94 may be pushed manually or by a powered mechanism as is known in the art. Preferably, the reservoir 84 will be supplied evacuated of all air prior to depressing the plunger 94.

In use, vacuum is preferably applied to the premold 112. As this occurs, resin is drawn by suction from the reservoir 84 through the tubing 86 and valve 88 and into the premold envelope 22. The premold envelope 22 is filled and the reinforcing material 20 within the premold envelope 22 is preferably permeated. After the reinforcing materials within envelope 22 have been infused with resin, the valve 88 is closed and the tubing is disconnected from the premold 112. Self sealing ports (59) of the type well known to the pharmaceutical industry for sealing liquid drug containers will be affixed at the juncture of the filling and suction tubes 58, 60 and the filling and suction ports 50, 54. These will prevent resin leakage after the tubing is removed.

The premold 112 is then placed on the patient's teeth. The pressure molding cap 14 will then be placed on over the premold 112 and pressurized to force the premold 112 into contact with the patient's teeth and gums as described above. Once the resin cures, the pressure may be released and the now-formed tooth fixation element 18 is ready for addition of the adjustment mechanisms. The practitioner may then assemble the right and left adjustment mechanisms 16 to the mandibular repositioning device 42 as described above.

It is contemplated that the tools to make a mandibular repositioning device 42 may be provided in a kit 96. The kit 96 preferably includes two preforms 12,112 and at least one set of adjustment mechanisms 16. The kit may further include a pressure molding cap 14. The kit 96 may further include a resin dispensing apparatus 78. The kit 96 may further include a support tray system 56.

Alternatively, as described above, the pressure molding cap 14 may be a reusable device that is not included in the kit. In such an embodiment the pressure molding cap 14 may be made of a material that is sterilizable. Alternatively, at least one thin sterile polymer bag (not shown) may be provided. The reusable pressure molding cap 14 may be placed in the polymer bag for use, the bag being discarded after use in the manner of many other devices in dental and medical procedure suites and operating rooms. The kit 96 may include at least one sterile polymer bag.

Although the above described methods teaches forming a first tooth fixation element 18 and then forming a second tooth fixation element 18, it is contemplated that two pressure molding caps 14 may be provided and that both tooth fixation elements 18 may be formed at the same time. It is further contemplated that a single pressure molding cap 18 may be provided which would engage both the top and the bottom teeth at the same time to mold the first tooth fixation element 18 and second tooth fixation element 18 at the same time.

It is further contemplated that in place of screw adjustment mechanisms 16, the system may be provided with elastomeric mandibular advancement means (not shown) which may take the form of elastomeric bands or straps coupled to the top tooth fixation element and the bottom tooth fixation element as is known in the art and often used with other mandibular advancement devices presently available.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/We claim:

1. A method comprising:
providing a top premold and a bottom premold, each of the premolds having a flexible outer envelope, the outer envelope defining an interior cavity and reinforcing material, the reinforcing material being located within the interior cavity;
providing a cap, the cap being sized and configured to removably engage the top and bottom premold, the cap including an inflatable bladder;
forming the top premold to the top teeth;
forming the bottom premold to the bottom teeth;
installing adjustment hardware on the top premold and the bottom premold.

2. The method of claim 1 wherein the forming of the top premold step further comprises:
placing the top premold over the top teeth;
placing the cap over the top premold;
inflating the cap bladder; and
applying curing energy to the top premold.

3. The method of claim 2 wherein the forming the bottom premold step further comprises:
placing the bottom premold over the bottom teeth;
placing the cap over the bottom premold;
inflating the cap bladder; and
applying curing energy to the bottom premold.

4. The method of claim 3 wherein the premold further comprises resin located within the interior cavity.

5. The method of claim 4 wherein the applying steps further comprise applying heat to the premold.

6. The method of claim 5 wherein the applying steps further comprise applying indirect heat to the premold.

7. The method of claim 6 further wherein the applying steps further comprise providing infrared heat means in the cap bladder.

8. The method of claim 6 wherein the applying steps further comprise inserting heated liquid into the cap bladder.

9. The method of claim 6 wherein the applying steps further comprise providing surface heating means on the bladder.

10. The method of claim 5 wherein the applying steps further comprise applying direct heat to the premold.

11. The method of claim 10 wherein the applying steps further comprise providing resistance heating wire within the premold.

12. The method of claim 10 wherein the applying steps further comprise providing printed resistance heating circuits within the premold.

13. The method of claim 10 wherein the applying steps further comprise providing carbon fiber fabric within the premold.

14. The method of claim 10 wherein the applying steps further comprise providing metallic fabric within the premold.

15. The method of claim 4 wherein the curing energy takes the form of light.

16. The method of claim 3 wherein the premold further comprises at least one entrance port formed in the outer envelope, the entrance port extending to the interior cavity.

17. The method of claim 16 wherein the premold further comprises:
at least one distribution channel, the at least one distribution channel located within the interior cavity and being in fluid communication with the entrance port; and
at least one evacuation hole formed in the outer envelope, the at least one evacuation hole being in fluid communication with the at least one of the at least one distribution channels.

18. The method of claim 17 wherein the forming steps further comprise filling the premold with a mixture of resin and catalyst.

19. The method of claim 17 wherein the forming steps further comprise filling the premold prior to insertion into the patient's mouth.

20. The method of claim 19 wherein the forming steps further comprise providing a support tray, the support tray having a base and a raised portion extending from the base, the raised portion being sized and configured to matingly engage the premold.

21. The method of claim 20 wherein the forming steps further comprise
placing the premold on the support tray;
attaching a filling tube to the entry port;
attaching a suction tube to the evacuation port; and
filling the premold with a mixture of resin and catalyst through the filling tube.

22. A system comprising
at least one premold, the premold having a flexible outer envelope, the outer envelope defining an interior cavity and reinforcing material, the reinforcing material located within the interior cavity;
at least one cap, the cap being sized and configured to removably engage the top and bottom premold, the cap including an inflatable bladder; and
adjustment means.

23. The system of claim 22 wherein the at least one premold includes a mixture of resin and catalyst in the interior cavity.

24. The system of claim 22 wherein the premold includes resistance heating wire within the interior cavity.

25. The system of claim 22 wherein the premold includes resistance heating circuit within the interior cavity.

26. The system of claim 22 wherein the premold includes carbon fiber fabric within the interior cavity.

27. The system of claim 22 wherein the premold includes metallic fabric with low impedence conductor edges within the interior cavity.

28. The system of claim 22 wherein the premold includes photoinitiated resin within the interior cavity.

29. The system of claim 22 wherein the premold includes at least one entrance port, the entrance port extending through the outer envelope to the interior cavity.

30. The system of claim 23 wherein the premold includes at least one distribution channel within the interior cavity, the distribution channel being in fluid communication with the entrance port.

31. The system of claim 23 wherein the premold includes at least one evacuation port, the evacuation port extending through the outer envelope to the interior cavity

32. The system of claim 22 wherein the cap bladder includes at least one heating element.

33. The system of claim 22 wherein the cap bladder includes at least one infrared heating element.

34. The system of claim 22 wherein the system includes a filling tray, the filling tray including a base and a raised portion, the raised portion being sized and configured to engage the at least one premold.

35. The system of claim 29 wherein the system includes a filling syringe, the filling syringe being sized and configured to provide a mixture of resin and catalyst to the entrance port.
